(19) United States
(12) Patent Application Publication
(10) Pub. No.: US 2023/0107516 A1
(43) Pub. Date: Apr. 6, 2023

(54) HYDRAULIC SERIAL REPHASING CIRCUITS

(71) Applicant: Lippert Components, Inc., Elkhart, IN (US)

(72) Inventors: Robert L. TIEDGE, Granger, IN (US); Mark KINDER, Clarks Hill, IN (US)

(21) Appl. No.: 17/958,713

(22) Filed: Oct. 3, 2022

Related U.S. Application Data
(60) Provisional application No. 63/251,189, filed on Oct. 1, 2021.

(51) Int. Cl. F15B 13/02; F15B 15/20; B63C 5/00; F15B 11/16

(52) U.S. Cl. CPC F15B 13/02; B63C 5/00; F15B 11/16; F15B 15/202

(57) ABSTRACT

A hydraulic circuit includes a hydraulic power unit, a first cylinder pair coupled with the hydraulic power unit, and a second cylinder pair coupled with the hydraulic power unit in parallel with the first cylinder pair. Re-phasing valves coupled with each cylinder of the first and second cylinder pairs are activated when a respective one of the cylinders reaches one of a fully extended or a fully retracted position. The hydraulic circuit incorporates the serially plumbed, re-phasing cylinders for synchronized movement in a system with multiple pairs of cylinders.

### CROSS-REFERENCES TO RELATED APPLICATIONS

This application claims the benefit of U.S. Provisional Pat. Application No. 63/251,189, filed Oct. 1, 2021, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to hydraulic circuits and, more particularly, to hydraulic circuits using serially plumbed, re-phasing cylinders for synchronized movement in a system with multiple pairs of cylinders.

Serial re-phasing has been commonly utilized in spray tractor steering systems. In these existing systems, the cylinders are identical in size and are plumbed such that as one cylinder extends, a downstream cylinder retracts at the same rate. Existing systems have typically been utilized in tractor/agricultural machines and often include only a single pair of cylinders or use a circuit that includes multiple individually-working cylinders.

There are applications where cylinders or other displacement mechanisms benefit from synchronized activation. For example, slide-out rooms in recreational vehicles (RVs) may be extended and retracted with mechanisms cooperable with sides of the room. Without synchronized activation, the room could get stuck or twisted. Slide-out rooms are currently synchronized side to side by mechanical means or flow dividers. These flow dividers are historically not very accurate.

Serial re-phasing has not been used in systems that have multiple pairs of cylinders.

### SUMMARY

The hydraulic system of the described embodiments includes multiple pairs of cylinders that utilize serial re-phasing to synchronize a mechanism like a platform lift or room slide-out. Although the hydraulic circuits are configured to synchronize the multiple pairs of cylinders, individual pairs could also be actuated separately. Serial re-phasing cylinders in pairs is more effective in synchronization.

In some embodiments, the upstream cylinder and the downstream cylinder are different sizes, while the head volume of the smaller cylinder may almost exactly match the rod volume of the larger cylinder.

A hydraulic power unit (HPU) drives the cylinders. In some embodiments, the HPU is bi-rotational, although a unidirectional pump and valve could be used.

In an exemplary embodiment, a hydraulic circuit includes a hydraulic power unit, a first cylinder pair coupled with the hydraulic power unit, a second cylinder pair coupled with the hydraulic power unit in parallel with the first cylinder pair, and a re-phasing valve coupled with each cylinder of the first and second cylinder pairs. The re-phasing valves are activated when a respective one of the cylinders reaches one of a fully extended position or a fully retracted position.

The hydraulic circuit may further include first and second solenoid valves interposed between the hydraulic power unit and the respective first and second cylinder pairs.

Each of the cylinders of the first and second cylinder pairs may include a head volume and a rod volume, where the first cylinder pair may include a first upstream cylinder connected in series with a first downstream cylinder, and where the second cylinder pair may include a second upstream cylinder connected in series with a second downstream cylinder. In this context, the head volume of the first upstream cylinder may be substantially equal to the rod volume of the first downstream cylinder, and the head volume of the second upstream cylinder may be substantially equal to the rod volume of the second downstream cylinder. The first upstream cylinder and the second upstream cylinder may be smaller than the first downstream cylinder and the second downstream cylinder, respectively.

In some embodiments, the re-phasing valves may be activated when the cylinders reach the fully extended position.

The hydraulic circuit may be cooperable with a pontoon slide-out assembly, where the hydraulic power unit displaces the pontoon slide-out assembly between a retracted position and an extended position, and the first cylinder pair and the second cylinder pair may be operated simultaneously.

A third cylinder pair may be coupled with the hydraulic power unit in parallel with the first and second cylinder pairs. In this context, the hydraulic circuit may further include first, second and third solenoid valves interposed between the hydraulic power unit and the respective first, second and third cylinder pairs. The hydraulic circuit may be cooperable with a trailer including three slide-out rooms, where each of the first, second and third cylinder pairs may be respectively associated with one of the three slide-out rooms, and where the first cylinder pair, the second cylinder pair and the third cylinder pair may be operated simultaneously, in pairs, or independently via the first, second and third solenoid valves.

In another exemplary embodiment, a boat lift includes a platform and the hydraulic circuit of the described embodiments coupled with the platform that is configured to raise and lower the platform. The first cylinder pair includes a first upstream cylinder acting on one of a forward section and an aft section of the platform and one side of the platform, and a first downstream cylinder acting on the other of the forward section and the aft section of the platform and an opposite side of the platform. The first upstream cylinder and the first downstream cylinder may be connected in series. The second cylinder pair may include a second upstream cylinder acting on the one of the forward section and the aft section of the platform and the opposite one side of the platform, and a second downstream cylinder acting on the other of the forward section and the aft section of the platform and the one side of the platform. The second upstream cylinder and the second downstream cylinder may be connected in series.

In yet another exemplary embodiment, a hydraulic circuit for lifting or displacing a structure with simultaneous activation of multiple pairs of cylinders includes a hydraulic power unit, a first cylinder pair coupled with the hydraulic power unit and positioned on one side of the structure, and a second cylinder pair coupled with the hydraulic power unit in parallel with the first cylinder pair and positioned on an opposite side of the structure. The hydraulic power unit simultaneously drives the first and second cylinder pairs. A re-phasing valve is coupled with each cylinder of the first and second cylinder pairs. The re-phasing valves are activated when a respective one of the cylinders reaches one of a fully extended or a fully retracted position, where the re-phasing valves open fluid flow across the hydraulic circuit without affecting a position of the cylinders.

### BRIEF DESCRIPTION OF THE DRAWINGS

These and other aspects and advantages will be described in detail with reference to the accompanying drawings, in which:

FIG. 1 is a hydraulic circuit diagram incorporating two pairs of cylinders with respective re-phasing valves;

FIG. 2 is a hydraulic circuit diagram incorporating three pairs of hydraulic cylinders; and

FIG. 3 is a hydraulic circuit diagram including cross-plumbed pairs of hydraulic cylinders.

### DETAILED DESCRIPTION

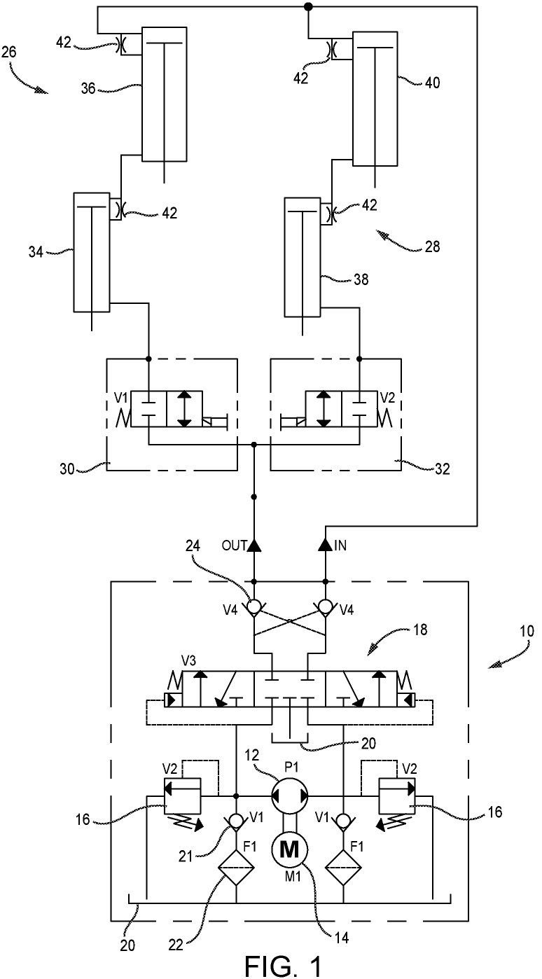

FIG. 1 shows a schematic hydraulic circuit including two pairs of cylinders using serial re-phasing to synchronize activation of the pairs of cylinders. An exemplary application of the circuit shown in FIG. 1 is a pontoon slide-out assembly. In this exemplary application, a pontoon deck is configured with telescoping structure so that a width of the pontoon can be varied (e.g., narrower for transport, wider for use). It is desirable when expanding the width of the pontoon deck to extend the sides of the deck simultaneously. The hydraulic circuit shown in FIG. 1 incorporates serial re-phasing valves to synchronize the multiple pairs of cylinders.

The circuit includes a hydraulic power unit (HPU) 10 that drives hydraulic fluid flow through the system. Hydraulic power units generally are known, and specific details of the HPU 10 shown in the figures will not be described.

Generally, the HPU 10 includes a pump 12 driven via a motor 14. A pair of adjustable relief valves 16 prevent over pressurization of the circuit during extension and retraction. The HPU 10 also includes a rapid purge valve 18 that communicates hydraulic fluid to a reservoir 20. The rapid purge valve 18 permits air in the circuit to bubble out into the reservoir, enabling the pump to draw non-aerated hydraulic fluid (e.g., oil) for the circuit. The return lines to the reservoir 20 may be provided with check valves 21 and mesh screens 22.

The HPU 10 also includes a pair of pilot-operated check valves 24 that serve to block hydraulic fluid flow until the system reaches a pre-set pressure. The HPU 10 shown in FIGS. 1-3 is bi-rotational, although a unidirectional pump and valve could be used.

In some embodiments, with continued reference to FIG. 1, the hydraulic circuit includes a first cylinder pair 26 coupled with the HPU 10 and a second cylinder pair 28 coupled with the HPU 10 in parallel with the first cylinder pair 26. First and second solenoid valves 30, 32 may be interposed between the HPU 10 and the respective first and second cylinder pairs 26, 28. The solenoid valves 30, 32 provide for electrical (i.e., switch) control for activating the cylinder pairs 26, 28. With both solenoid valves 30, 32 activated, the HPU 10 drives the cylinder pairs 26, 28 simultaneously. If desired by a user, the solenoid valves 30, 32 can be activated independently.

The first cylinder pair 26 includes a first upstream cylinder 34 and a first downstream cylinder 36. In a similar context, the second cylinder pair 28 includes a second upstream cylinder 38 and a second downstream cylinder 40. In some embodiments, the first and second upstream cylinders 34, 38 are smaller than the first and second downstream cylinders 36, 40. The cylinders 34, 36, 38, 40 may be configured such that the head volume of the first and second upstream cylinders 34, 38 is substantially equal to the rod volume of the first and second downstream cylinders 36, 40. The HPU 10 drives the rod end of the smaller pair of cylinders 34, 38. The rod ends of the smaller pair of cylinders are the only portions of the circuit that are in parallel. The head ends of the smaller pair of cylinders 34, 38 then power the rod ends of the larger cylinders 36, 40 in series, as the head end volume of the smaller cylinders equals, or very nearly equals, the rod end volumes of the larger cylinders. As each smaller cylinder powers the rod ends of the larger cylinders in series, it drives opposite sides or corners of the structure or platform, and the rigidity of the platform or bunk forces the system to remain level.

Each of the cylinders may be provided with a re-phasing valve 42. The re-phasing valves 42 are activated when the cylinders 34, 36, 38, 40 reach one of a fully extended position or a fully retracted position. In the embodiment shown in FIG. 1, the re-phasing valves 42 are activated when the cylinders 34, 36, 38, 40 reach the fully extended position. The re-phasing valves 42 enable hydraulic fluid to continue to flow through the circuit after the cylinders have reached the fully extended or retracted position (depending on a position of the re-phasing valves 42). The re-phasing valve 42 allows the cylinders to be aligned during set up and re-phased in the event of oil leakage/bypass during usage or after service work. The re-phasing valves 42 enable the circuit to purge air or particles in the system that could affect simultaneous operation of the cylinders 34, 36, 38, 40. The re-phasing valves 42 may also serve to compensate for drift due to system leakage.

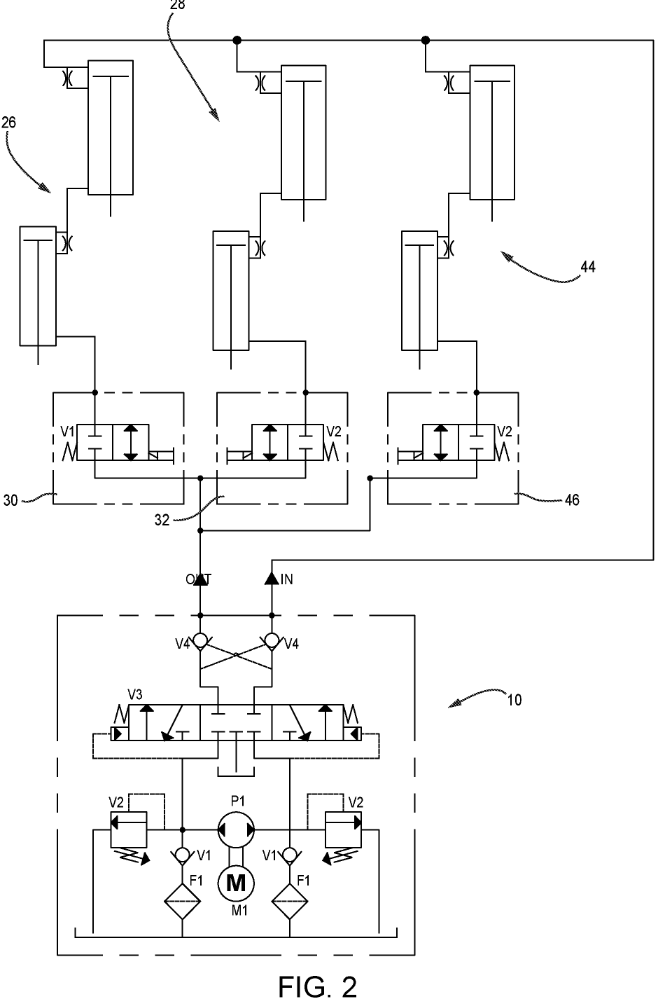

FIG. 2 shows an exemplary application including a third cylinder pair 44 coupled with the HPU 10 in parallel with the first cylinder pair 26 and the second cylinder pair 28. A third solenoid valve 46 may be interposed between the HPU 10 and the third cylinder pair 44.

In an exemplary application of the hydraulic circuit shown in FIG. 2, the circuit may be cooperable with a trailer including three slide-out rooms, where each of the first, second and third cylinder pairs 26, 28, 44 is respectfully associated with one of the three slide-out rooms. In operation, the first cylinder pair 26, the second cylinder pair 28 and the third cylinder pair 44 may be operated simultaneously, in pairs or independently via the first, second and third solenoid valves 30, 32, 46.

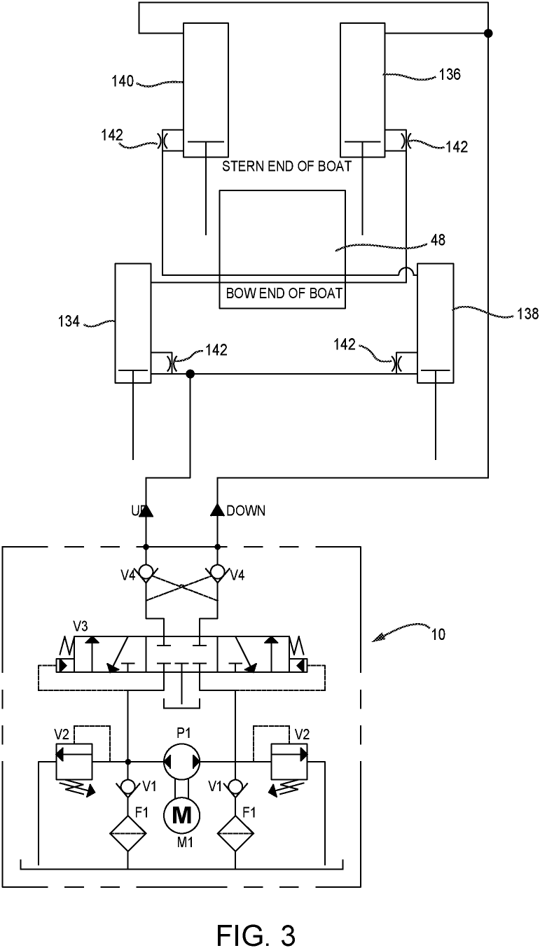

FIG. 3 shows an alternative exemplary application of the hydraulic circuit and utilizes cross-plumbing along with the serial re-phasing valves. The cross-plumbed configuration is particularly suited for a boat lift including a platform 48 (shown schematically in FIG. 3) to which the hydraulic circuit of the described embodiments is coupled. The hydraulic circuit is configured to raise and lower the platform 48.

In this embodiment, the first cylinder pair includes a first upstream cylinder 134 acting on one of a forward section and an aft section of the platform 48 (shown schematically acting on the aft section of the platform 48 in FIG. 3), and one side of the platform 48 (shown on the port side of the platform 48 in FIG. 3). The first cylinder pair also includes a first downstream cylinder 136 acting on the other of the forward section and the aft section of the platform 48 (shown schematically acting on the forward section of the platform in FIG. 3) and an opposite side of the platform 48 (shown on the starboard side of the platform in FIG. 3).

The second cylinder pair includes a second upstream cylinder 138 acting on the same section of the platform as the first upstream cylinder 134 but on the opposite side of the platform 48, and a second downstream cylinder 140 acting on the same section of the platform as the first downstream cylinder 136 but on an opposite side of the platform 48.

The cross-plumbed cylinder pairs help to keep the cylinders 134, 136, 138, 140 in sync. In the exemplary boat lift application, the bunk or understructure is rigid so twisting of the lift platform 48 is avoided, and the cross-plumbed cylinder pairs can effectively raise and lower the platform 48 while keeping the platform level or at a preferred orientation. As shown in FIG. 3, the re-phasing valves 142 in this embodiment are activated when the cylinders 134, 136, 138, 140 reach their fully retracted position.

The hydraulic circuit of the described embodiments incorporates serially plumbed, re-phasing cylinders for synchronized movement in a system with multiple pairs of cylinders. The system is plumbed serially end-to-end to provide fore and aft synchronization, plumbed serially side-to-side for synchronization of both lateral sides of a structure, and in some embodiments, is cross-plumbed to provide rigidity of a lift platform or the like to avoid platform twist.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A hydraulic circuit comprising:
a hydraulic power unit;
a first cylinder pair coupled with the hydraulic power unit;
a second cylinder pair coupled with the hydraulic power unit in parallel with the first cylinder pair; and
a re-phasing valve coupled with each cylinder of the first and second cylinder pairs, the re-phasing valves being activated when a respective one of the cylinders reaches one of a fully extended position or a fully retracted position.

2. A hydraulic circuit according to claim 1, further comprising first and second solenoid valves interposed between the hydraulic power unit and the respective first and second cylinder pairs.

3. A hydraulic circuit according to claim 1, wherein each of the cylinders of the first and second cylinder pairs comprises a head volume and a rod volume, wherein the first cylinder pair comprises a first upstream cylinder connected in series with a first downstream cylinder, and wherein the second cylinder pair comprises a second upstream cylinder connected in series with a second downstream cylinder, the head volume of the first upstream cylinder being substantially equal to the rod volume of the first downstream cylinder, and the head volume of the second upstream cylinder being substantially equal to the rod volume of the second downstream cylinder.

4. A hydraulic circuit according to claim 3, wherein the first upstream cylinder and the second upstream cylinder are smaller than the first downstream cylinder and the second downstream cylinder, respectively.

5. A hydraulic circuit according to claim 1, wherein the re-phasing valves are activated when the cylinders reach the fully extended position.

6. A hydraulic circuit according to claim 1 cooperable with a pontoon slide-out assembly, the hydraulic power unit displacing the pontoon slide-out assembly between a retracted position and an extended position, wherein the first cylinder pair and the second cylinder pair are operated simultaneously.

7. A hydraulic circuit according to claim 1, further comprising a third cylinder pair coupled with the hydraulic power unit in parallel with the first and second cylinder pairs.

8. A hydraulic circuit according to claim 7, further comprising first, second and third solenoid valves interposed between the hydraulic power unit and the respective first, second and third cylinder pairs.

9. A hydraulic circuit according to claim 8 cooperable with a trailer including three slide-out rooms, wherein each of the first, second and third cylinder pairs is respectively associated with one of the three slide-out rooms, wherein the first cylinder pair, the second cylinder pair and the third cylinder pair are operated simultaneously, in pairs, or independently via the first, second and third solenoid valves.

10. A boat lift comprising:
a platform; and
a hydraulic circuit according to claim 1 coupled with the platform that is configured to raise and lower the platform,
wherein the first cylinder pair comprises a first upstream cylinder acting on one of a forward section and an aft section of the platform and one side of the platform and a first downstream cylinder acting on the other of the forward section and the aft section of the platform and an opposite side of the platform, wherein the first upstream cylinder and the first downstream cylinder are connected in series, and
wherein the second cylinder pair comprises a second upstream cylinder acting on the one of the forward section and the aft section of the platform and the opposite one side of the platform and a second downstream cylinder acting on the other of the forward section and the aft section of the platform and the one side of the platform, wherein the second upstream cylinder and the second downstream cylinder are connected in series.

11. A boat lift according to claim 10, wherein the re-phasing valves are activated when the cylinders reach the fully retracted position.

12. A hydraulic circuit for lifting or displacing a structure with simultaneous activation of multiple pairs of cylinders, the hydraulic circuit comprising:
a hydraulic power unit;
a first cylinder pair coupled with the hydraulic power unit and positioned on one side of the structure;
a second cylinder pair coupled with the hydraulic power unit in parallel with the first cylinder pair and positioned on an opposite side of the structure, the hydraulic power unit simultaneously driving the first and second cylinder pairs; and
a re-phasing valve coupled with each cylinder of the first and second cylinder pairs, the re-phasing valves being activated when a respective one of the cylinders reaches one of a fully extended or a fully retracted position, the re-phasing valves opening fluid flow across the hydraulic circuit without affecting a position of the cylinders.

13. A hydraulic circuit according to claim 12, further comprising first and second solenoid valves interposed between the hydraulic power unit and the respective first and second cylinder pairs.

14. A hydraulic circuit according to claim 12, wherein each of the cylinders of the first and second cylinder pairs comprises a head volume and a rod volume, wherein the first cylinder pair comprises a first upstream cylinder connected in series with a first downstream cylinder, and wherein the second cylinder pair comprises a second upstream cylinder connected in series with a second downstream cylinder, the head volume of the first upstream cylinder being substantially equal to the rod volume of the first downstream cylinder, and the head volume of the second upstream cylinder being substantially equal to the rod volume of the second downstream cylinder.

15. A hydraulic circuit according to claim 14, wherein the first upstream cylinder and the second upstream cylinder are smaller than the first downstream cylinder and the second downstream cylinder, respectively.

16. A hydraulic circuit according to claim 12, further comprising a third cylinder pair coupled with the hydraulic power unit in parallel with the first and second cylinder pairs.

17. A hydraulic circuit according to claim 16, further comprising a third solenoid valve interposed between the hydraulic power unit and the third cylinder pair.
